(19) United States
(12) Patent Application Publication
(10) Pub. No.: US 2026/0164378 A1
(43) Pub. Date: Jun. 11, 2026

(54) Application of Joint Support of NFG and NCSG

(71) Applicant: Apple Inc., Cupertino, CA (US)

(72) Inventors: Qiming Li, Beijing (CN); Jie Cui, San Jose, CA (US); Yang Tang, San Jose, CA (US); Dawei Zhang, Saratoga, CA (US); Yuexia Song, Beijing (CN); Konstantinos Sarrigeorgidis, Los Gatos, CA (US)

(21) Appl. No.: 18/849,455

(22) PCT Filed: Sep. 26, 2023
(86) PCT No.: PCT/CN2023/121608

§ 371 Date: Sep. 20, 2024

(51) Int. Cl. H04W 56/00; H04W 8/22; H04W 24/10

(52) U.S. Cl. CPC H04W 56/0015; H04W 8/22; H04W 24/10

(57) ABSTRACT

An apparatus of a user equipment (UE) comprising one or more processors coupled to a memory and configured to decode, from signaling received from a next generation node B (gNB), an indication to enable one of Need For Gaps (NFG) or Network Configured Small Gap (NCSG) gapless measuring of a target synchronization signal block (SSB); enable the NFG or NCSG gapless measuring based on the indication from the gNB for Radio Resource Management (RRM) measurements of the target SSB; and perform the RRM measurements of the target SSB using the NFG or NCSG gapless measuring as indicated by the gNB.

### FIELD

Embodiments of the invention relate to wireless communications, including apparatuses, systems, and methods for application of joint support of NeedForGaps (NFG) and Network Controlled Small Gap (NCSG) in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

NeedForGaps (NFG) and Network Controlled Small Gap (NCSG) information elements (IEs) were introduced in Release 16 (R16) and Release 17 (R17) of the third generation partnership project (3GPP) standards, respectively. The intention is to support Radio Resource Management (RRM) measurement without gap. Typical user equipment (UE) implementations to support NFG and NCSG IEs are similar, i.e. the UE uses an additional radio frequency (RF) chain or adjusts bandwidth (BW) to cover a target Synchronization Signal Block (SSB). The NFG and NCSG IEs are independent features in the 3GPP standards. If a network (NW) and the UE support both NFG and NCSG features, then the UE will not know which feature to enable. The UE will not know which measurement behavior to implement.

### SUMMARY

Embodiments relate to wireless communications, and more particularly to apparatuses, systems, and methods for an apparatus of a user equipment (UE), the apparatus comprising one or more processors, coupled to a memory, configured to: decode, from signaling received from a next generation node B (gNB), an indication to enable one of Need For Gaps (NFG) or Network Configured Small Gap (NCSG) gapless measuring of a target synchronization signal block (SSB); enable the NFG or NCSG gapless measuring based on the indication from the gNB for Radio Resource Management (RRM) measurements of the target SSB; and perform the RRM measurements of the target SSB using the NFG or NCSG gapless measuring as indicated by the gNB.

Other embodiments relate to an apparatus of a user equipment (UE), the apparatus comprising: one or more processors, coupled to a memory, configured to: decode, from signaling received from a next generation node B (gNB), a gap configuration indication to use an existing gap configuration for Radio Resource Management (RRM) measurements on a target frequency band; determine whether gapless measuring was previously indicated to the gNB for the RRM measurements of the target SSB for the target frequency band; and perform the RRM measurements of the target SSB using the gapless measuring based on the determination and the configuration indication.

Other embodiments relate to an apparatus of a user equipment (UE), the apparatus comprising: one or more processors, coupled to a memory, configured to: encode, for transmission to a next generation node B (gNB), a capability message indicating support of the UE for Need For Gaps (NFG) and Network Controlled Small Gaps (NCSG) for radio resource management (RRM) measurements of target synchronization signal block (SSB) on one or more frequency bands; initiate a timer upon transmission of the capability message; and perform the RRM measurements of the target SSB on the one or more frequency bands that indicate support of NFG with no-gap based on determining the gNB failed to provide gap configuration information to the UE prior to an expiration of the timer.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6 illustrates an example of a baseband processor architecture for a UE, according to some embodiments.

FIG. 7 illustrates an example block diagram of an interface of baseband circuitry according to some embodiments.

FIG. 8 illustrates an example schematic bandwidth diagram in the time domain and the inter-frequency range according to some embodiments.

FIG. 9 illustrates an example schematic bandwidth diagram in the time domain and the inter-frequency range according to some embodiments.

FIG. 10 illustrates an example flow diagram of procedures for signaling between a gNB and a UE according to some embodiments.

FIG. 11 illustrates an example schematic frequency band diagram according to some embodiments.

FIG. 12 illustrates an example of a method for determining a measurement gap configuration for RRM measurements according to some embodiments.

FIG. 13 illustrates an example of a method for determining a measurement gap configuration for RRM measurements according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. 5G NR can support scalable channel bandwidths from 5 MHz to 100 MHz in Frequency Range 1 (FR1) and up to 400 MHz in FR2. In other radio access technologies, WLAN channels may be 22 MHz wide while Bluetooth channels may be 1 MHz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system will update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as set by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

The example embodiments may be further understood with reference to the following description and the related appended drawings, wherein like elements are provided with the same reference numerals. The example embodiments relate to configuring RRM measurement for UEs without gap.

The example embodiments are described with regard to communication between a next generation Node B (gNB) and a user equipment (UE). However, reference to a gNB or a UE is merely provided for illustrative purposes. The example embodiments may be utilized with any electronic component that may establish a connection to a network and is configured with the hardware, software, and/or firmware to support gapless RRM measurements. Therefore, the gNB or UE as described herein is used to represent any appropriate type of electronic component.

The example embodiments are also described with regard to a fifth generation (5G) New Radio (NR) network that may configure a UE to perform measurements of a target SSB with no-gap and with-interruption, or no-gap and no-interruption. However, reference to a 5G NR network is merely provided for illustrative purposes. The example embodiments may be utilized with any appropriate type of network.

Throughout this description various information elements (IEs) are referred to by specific names. It should be understood that these names are only examples and the IEs carrying the information referred to throughout this description may be referred to by other names by various entities.

In legacy operation (e.g., Release 15 (Rel-15) of the third generation partnership project (3GPP)), when the target SSB configured for RRM measurement is outside the active BWP for the UE, the network has to configure a measurement gap for the UE to conduct the measurements. During the measurement gap, the UE can tune its radio frequency (RF) circuitry away from the active BWP to cover the target SSB. Thus, in this scenario, the UE cannot be scheduled during the measurement gap.

NeedForGaps (NFG) and Network Controlled Small Gap (NCSG) information elements (IEs) were introduced in Release 16 (R16) and Release 17 (R17) of the third generation partnership project (3GPP) standards, respectively. The intention is to support Radio Resource Management (RRM) measurement without gap. Typical user equipment (UE) implementations to support NFG and NCSG IEs are similar, i.e. the UE uses an additional radio frequency (RF) chain or adjusts bandwidth (BW) to cover a target Synchronization Signal Block (SSB). The NFG and NCSG IEs are independent features in the 3GPP standards. If a network (NW) and the UE support both NFG and NCSG features, then the UE will not know which feature to enable. The UE will not know which measurement behavior to implement.

Throughout this description, the terms “no-gap,” “gapless,” “without a measurement gap” or “no measurement gap” should be understood to indicate that the UE has the capability of and/or is configured to perform measurements of a target SSB without having to tune the UE away from the frequency the UE is currently monitoring, e.g., no measurement gap is used for the measurements of the target SSB.

The example embodiments provide various manners for a network to determine whether a UE supports gapless RRM measurements. The determination may be based on a dependency between different categories or types of RRM measurements that the UE may be configured to perform. The example embodiments are described in greater detail below.

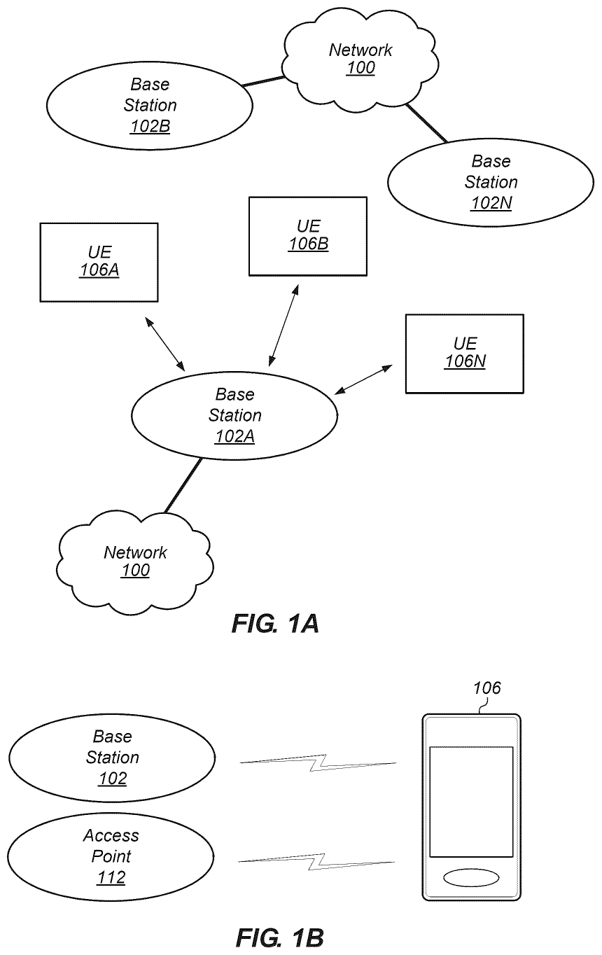

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, also referred to as the Evolved Universal Terrestrial Radio Access Network (E-UTRAN, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1A, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1A might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

In some embodiments, the base stations 102 can be configured for inter-band SSB-less carrier aggregation, as further described herein. One base station 102A may be a primary cell (PCell) with a radio resource control (RRC) connection, while another base station 102N may be a secondary cell (SCell) that is configured for inter-band and non-contiguous communication without a synchronization signal block (SSB-less).

FIG. 1B illustrates user equipment 106 (e.g., one of the devices 106A through 106N) in communication with a base station 102 and an access point 112, according to some embodiments. The UE 106 may be a device with both cellular communication capability and non-cellular communication capability (e.g., Bluetooth, Wi-Fi, and so forth) such as a mobile phone, a hand-held device, a computer or a tablet, or virtually any type of wireless device.

The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1×RTT/1×EV-DO/HRPD/eHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM), and separate radios for communicating using each of Wi-Fi and Bluetooth. Other configurations are also possible.

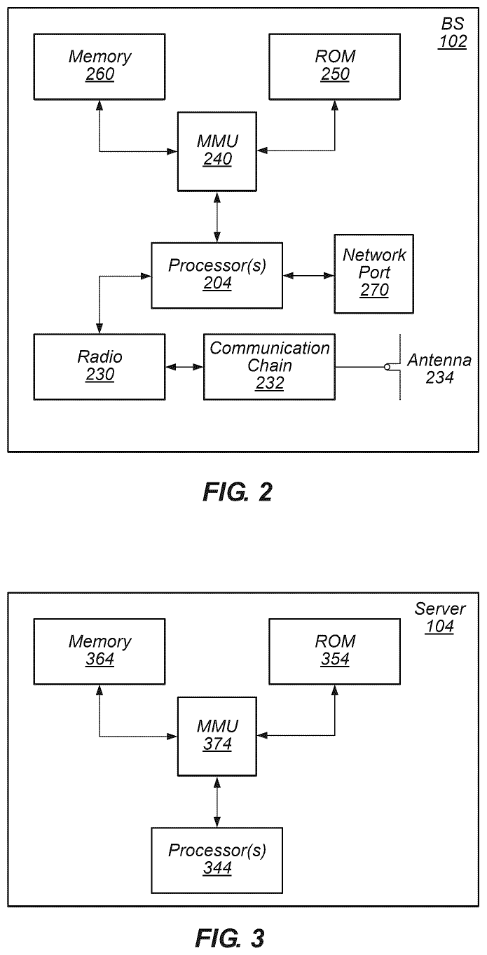

### FIG. 2: Block Diagram of a Base Station

FIG. 2 illustrates an example block diagram of a base station 102, according to some embodiments. It is noted that the base station of FIG. 2 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

In some embodiments, the base station or gNB 102, and/or processors 204 thereof, can be capable of and configured to decode indications from the UE 106, determine UE capabilities based on the indications, and encode for transmission to the UE 106 downlink signals to enable the UE 106 to perform measurements of the target SSB without gap or gapless measurement.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

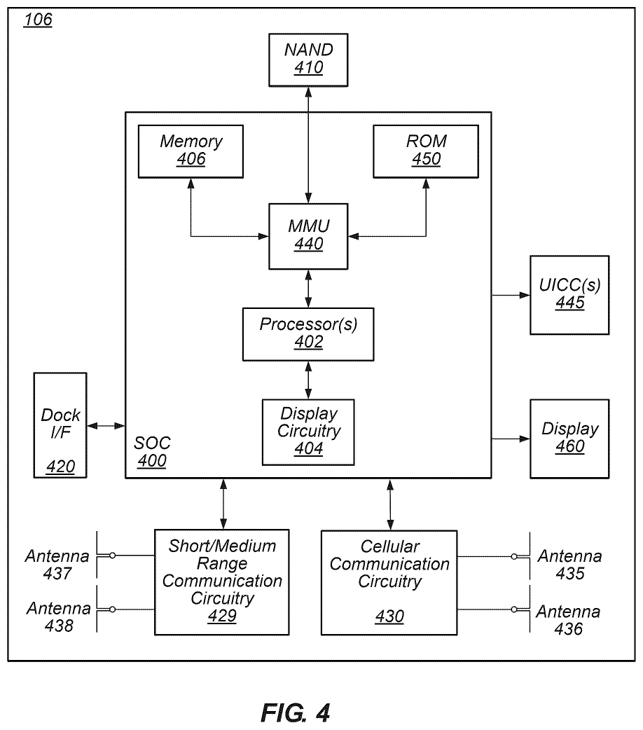

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., and short to medium range wireless communication circuitry 429 (e.g., Bluetooth™ and WLAN circuitry). In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMS may include components such as a processor and/or a memory; instructions for performing SIM/eSIM functionality may be stored in the memory and executed by the processor. In some embodiments, the UE 106 may include a combination of removable smart cards and fixed/non-removable smart cards (such as one or more eUICC cards that implement eSIM functionality), as desired. For example, the UE 106 may comprise two embedded SIMs, two removable SIMs, or a combination of one embedded SIMs and one removable SIMs. Various other SIM configurations are also contemplated.

As noted above, in some embodiments, the UE 106 may include two or more SIMs. The inclusion of two or more SIMs in the UE 106 may allow the UE 106 to support two different telephone numbers and may allow the UE 106 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106 comprises two SIMs, the UE 106 may support Dual SIM Dual Active (DSDA) functionality. The DSDA functionality may allow the UE 106 to be simultaneously connected to two networks (and use two different RATs) at the same time, or to simultaneously maintain two connections supported by two different SIMs using the same or different RATs on the same or different networks. The DSDA functionality may also allow the UE 106 to simultaneously receive voice calls or data traffic on either phone number. In certain embodiments the voice call may be a packet switched communication. In other words, the voice call may be received using voice over LTE (VoLTE) technology and/or voice over NR (VoNR) technology. In some embodiments, the UE 106 may support Dual SIM Dual Standby (DSDS) functionality. The DSDS functionality may allow either of the two SIMs in the UE 106 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

In some embodiments, the UE 106 and/or the processors 402 thereof can be configured to and/or capable of performing various operations related to reporting a UE capability for NFG and NCSG gapless measurement, as described herein.

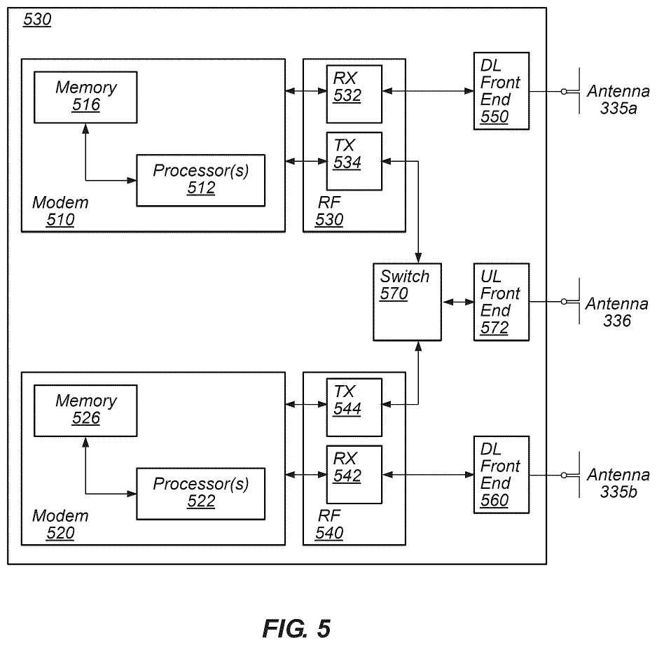

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular communication circuitry 430, may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 530 may couple (e.g., communicatively; directly or indirectly) to one or more antennas, such as antennas 435a-b and 436 as shown (in FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

In some embodiments, the processors 512, 522 can be configured for inter-band SSB-less carrier aggregation, as further described herein.

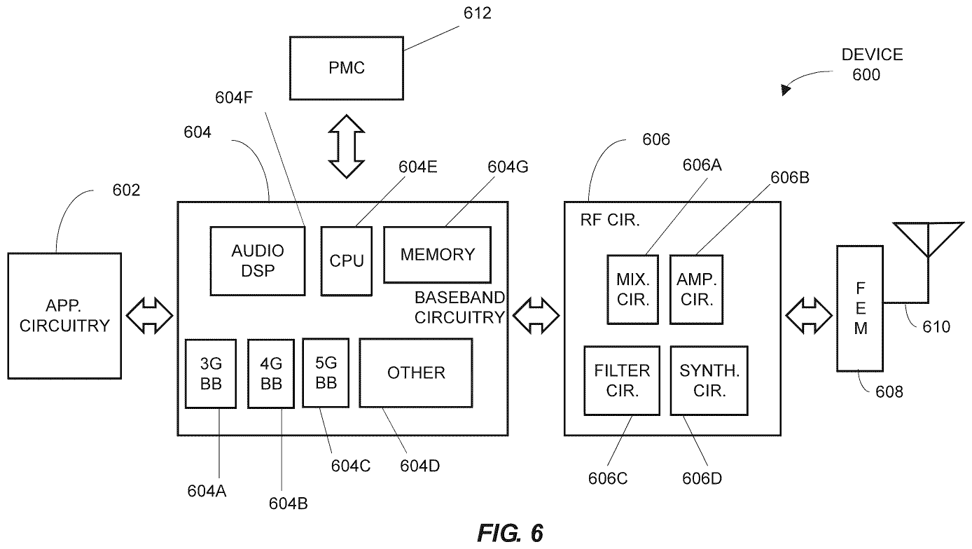

### FIG. 6: Block Diagram of a Baseband Processor Architecture for a UE

FIG. 6 illustrates example components of a device 600 in accordance with some embodiments. It is noted that the device of FIG. 6 is merely one example of a possible system, and that features of this disclosure may be implemented in any of various UEs, as desired.

In some embodiments, the device 600 may include application circuitry 602, baseband circuitry 604, Radio Frequency (RF) circuitry 606, front-end module (FEM) circuitry 608, one or more antennas 610, and power management circuitry (PMC) 612 coupled together at least as shown. The components of the illustrated device 600 may be included in a UE 106 or a RAN node. In some embodiments, the device 600 may include less elements (e.g., a RAN node may not utilize application circuitry 602, and instead include a processor/controller to process IP data received from an EPC). In some embodiments, the device 600 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 600. In some embodiments, processors of application circuitry 602 may process IP data packets received from an EPC.

The baseband circuitry 604 may include circuitry such as, but not limited to, one or more single-core or multi-core processors. The baseband circuitry 604 may include one or more baseband processors or control logic to process baseband signals received from a receive signal path of the RF circuitry 606 and to generate baseband signals for a transmit signal path of the RF circuitry 606. Baseband processing circuity 604 may interface with the application circuitry 602 for generation and processing of the baseband signals and for controlling operations of the RF circuitry 606. For example, in some embodiments, the baseband circuitry 604 may include a third generation (3G) baseband processor 604A, a fourth generation (4G) baseband processor 604B, a fifth generation (5G) baseband processor 604C, or other baseband processor(s) 604D for other existing generations, generations in development or to be developed in the future (e.g., second generation (2G), sixth generation (6G), etc.). The baseband circuitry 604 (e.g., one or more of baseband processors 604A-D) may handle various radio control functions that enable communication with one or more radio networks via the RF circuitry 606. In other embodiments, some or all of the functionality of baseband processors 604A-D may be included in modules stored in the memory 604G and executed via a Central Processing Unit (CPU) 604E. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, or constellation mapping/demapping functionality. In some embodiments, encoding/decoding circuitry of the baseband circuitry 604 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include one or more audio digital signal processor(s) (DSP) 604F. The audio DSP(s) 604F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the receive signal path of the RF circuitry 606 may include mixer circuitry 606a, amplifier circuitry 606b and filter circuitry 606c. In some embodiments, the transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a necessity. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c.

In some embodiments, the mixer circuitry 606a of the receive signal path and the mixer circuitry 606a of the transmit signal path may include two or more mixers and may be arranged for quadrature downconversion and upconversion, respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a necessity. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610. In various embodiments, the amplification through the transmit or receive signal paths may be done solely in the RF circuitry 606, solely in the FEM 608, or in both the RF circuitry 606 and the FEM 608.

In some embodiments, the FEM circuitry 608 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610).

In some embodiments, the PMC 612 may manage power provided to the baseband circuitry 604. In particular, the PMC 612 may control power-source selection, voltage scaling, battery charging, or DC-to-DC conversion. The PMC 612 may often be included when the device 600 is capable of being powered by a battery, for example, when the device is included in a UE. The PMC 612 may increase the power conversion efficiency while providing desirable implementation size and heat dissipation characteristics.

While FIG. 6 shows the PMC 612 coupled only with the baseband circuitry 604, in other embodiments the PMC 612 may be additionally or alternatively coupled with, and perform similar power management operations for, other components such as, but not limited to, application circuitry 602, RF circuitry 606, or FEM 608.

In some embodiments, the PMC 612 may control, or otherwise be part of, various power saving mechanisms of the device 600. For example, if the device 600 is in a radio resource control_Connected (RRC_Connected) state, where it is still connected to the RAN node as it expects to receive traffic shortly, then it may enter a state known as Discontinuous Reception Mode (DRX) after a period of inactivity. During this state, the device 600 may power down for brief intervals of time and thus save power.

If there is no data traffic activity for an extended period of time, then the device 600 may transition off to an RRC_Idle state, where it disconnects from the network and does not perform operations such as channel quality feedback, handover, etc. The device 600 goes into a very low power state and it performs paging where again it periodically wakes up to listen to the network and then powers down again. The device 600 may not receive data in this state, in order to receive data, it will transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 602 and processors of the baseband circuitry 604 may be used to execute elements of one or more instances of a protocol stack. For example, processors of the baseband circuitry 604, alone or in combination, may be used execute Layer 3, Layer 2, or Layer 1 functionality, while processors of the application circuitry 604 may utilize data (e.g., packet data) received from these layers and further execute Layer 4 functionality (e.g., transmission communication protocol (TCP) and user datagram protocol (UDP) layers). As referred to herein, Layer 3 (L3) may comprise a radio resource control (RRC) layer, described in further detail below. As referred to herein, Layer 2 (L2) may comprise a medium access control (MAC) layer, a radio link control (RLC) layer, and a packet data convergence protocol (PDCP) layer, described in further detail below. As referred to herein, Layer 1 (L1) may comprise a physical (PHY) layer of a UE/RAN node, described in further detail below. Accordingly, the baseband circuitry 604 can be used to encode a message for transmission between a UE and a gNB, or decode a message received between a UE and a gNB.

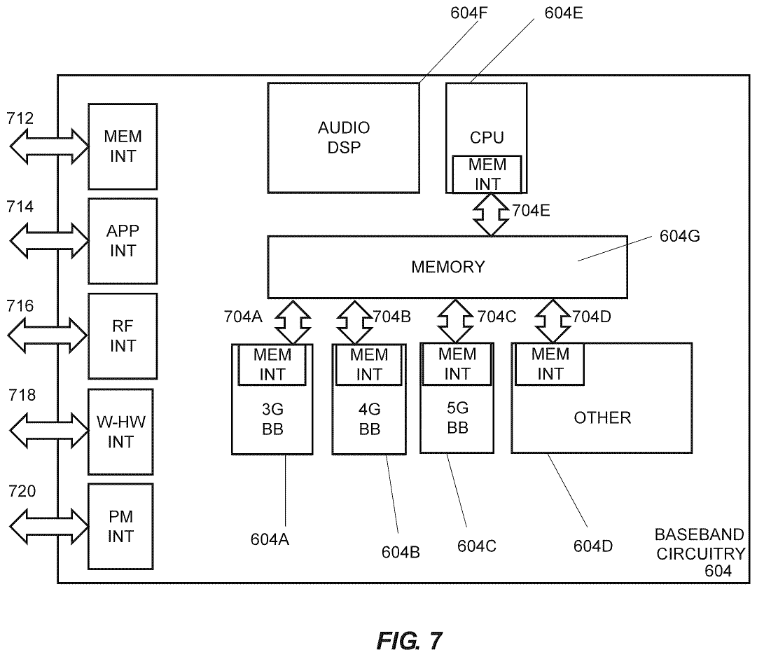

### FIG. 7: Block Diagram of an Interface of Baseband Circuitry

FIG. 7 illustrates example interfaces of baseband circuitry in accordance with some embodiments. It is noted that the baseband circuitry of FIG. 7 is merely one example of a possible circuitry, and that features of this disclosure may be implemented in any of various systems, as desired.

As discussed above, the baseband circuitry 604 of FIG. 6 may comprise processors 604A-604E and a memory 604G utilized by said processors. Each of the processors 604A-604E may include a memory interface, 704A-704E, respectively, to send/receive data to/from the memory 604G.

The baseband circuitry 604 may further include one or more interfaces to communicatively couple to other circuitries/devices, such as a memory interface 712 (e.g., an interface to send/receive data to/from memory external to the baseband circuitry 604), an application circuitry interface 7914 (e.g., an interface to send/receive data to/from the application circuitry 602 of FIG. 6), an RF circuitry interface 716 (e.g., an interface to send/receive data to/from RF circuitry 606 of FIG. 6), a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from the PMC 612.

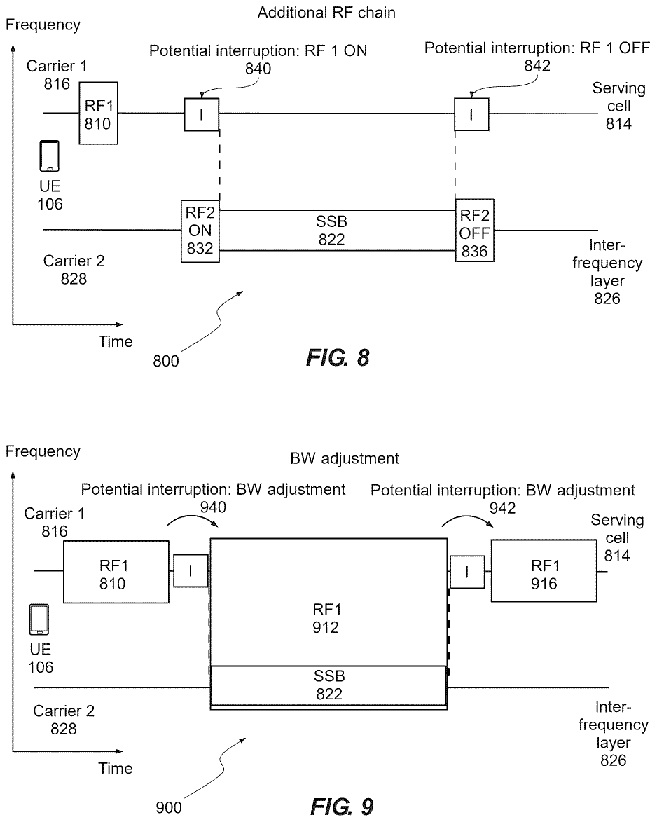

### FIGS. 8 and 9: Schematic Bandwidth Diagrams in the Time Domain and the Frequency Range

FIG. 8 is an illustration of a bandwidth diagram 800 in the time domain and the frequency range showing an additional radio frequency (RF) chain according to some example embodiments. In this example, it may be considered that the bandwidth diagram 800 is illustrating a downlink (DL) bandwidth on which one or more gNBs 102 are transmitting and the UE 106 is receiving. However, an uplink (UL) diagram would be similar to the DL bandwidth diagram 800, except that the UE 106 would be transmitting on the UL frequencies and the gNB 102 would be receiving. In addition, the types of signals transmitted/received in the DL and UL may be different.

Initially, the bandwidth diagram 800 shows a first radio frequency (RF1) band 810 of a serving cell 814 and first carrier (carrier 1) 816. An active bandwidth part (BWP) can be at least a portion of the first radio frequency (RF1) band 810 at the UE 106. The UE can be configured for a channel bandwidth (CBW) that is within the first radio frequency (RF1) band 810 containing the active BWP of the UE 106. Typically, in 5G networks, the CBW is a maximum transmission bandwidth (defined in terms of resource blocks (RBs) and guard bands on both ends of the frequency spectrum (with the guard bands defined in terms of (kilohertz) kHz). However, the CBW may be any group of contiguous frequencies. An active BWP frequency band can be defined within the CBW. The active BWP can be a set of contiguous frequencies within the CBW that is configured for the UE 106. Multiple UEs may be configured with the same active BWP. The UE 106 can be configured to receive Physical Downlink Shared Channel (PDSCH) transmissions, Physical Downlink Control Channel (PDCCH) transmissions, Channel State Information Reference Signals (CSI-RS), and Tracking Reference Signals (TRS) in the configured active BWP. Another manner of stating this is that the UE 106 may not expect to receive these signals outside of the active BWP.

Furthermore, a target SSB 822 can be defined in an inter-frequency layer 826 of a second carrier (carrier 2) 828. Multiple SSBs may be configured for a UE. The example embodiments described herein may be related to an SSB configured for layer 1 (L1) operations, e.g., RRM measurements, and the SSB 822 may be considered to be this type of SSB. The SSB 822 is outside the frequency range of the UE 106 on the serving cell 814 of the first carrier 816. The UE 106 may use a second RF chain configured for the second carrier frequency (RF2) 832 that is configured for the frequency range of the target SSB (e.g., SSB 822). The UE 106 may turn on the second RF chain configured for the second carrier frequency 832 to measure the SSB 822 for a certain time and then turn off the second RF chain 836 after measuring the SSB 822. When the UE 106 turns on the second RF chain 832 to measure the SSB 822, a potential interruption 840 may be introduced or be turned on with respect to the first frequency 810. Similarly, when the UE 106 turns off the second RF chain 836 after measuring the SSB 822, a potential interruption 842 may be introduced or be turned off with respect to the first frequency 810.

FIG. 9 is an illustration of a bandwidth diagram 900 in the time domain and the frequency range showing a BW adjustment according to some example embodiments. In this example, and as described above, it may be considered that the bandwidth diagram 900 is illustrating a downlink (DL) bandwidth on which the gNB 102 is transmitting and the UE 106 is receiving. However, an uplink (UL) diagram would be similar to the DL bandwidth diagram 900, except that the UE 106 would be transmitting on the UL frequencies and the gNB 102 would be receiving. In addition, the types of signals transmitted/received in the DL and UL may be different.

Initially, the bandwidth diagram 900 shows a first radio frequency (RF1) band 810 of a serving cell 814 and first carrier (carrier 1) 816. The UE 106 may periodically, occasionally and/or temporarily change the UE actual BW to use a larger bandwidth 912, e.g. increase the UE actual BW, to cover the target SSB (e.g., SSB 822) and the UE active BWP. The UE 106 can then change the UE actual BW to use a smaller bandwidth 916, e.g. decrease the UE actual BW, to a frequency range that includes the active BWP and excludes the target SSB, after the SSB 822 has been measured. Reducing the UE actual BW can significantly reduce power consumption at the UE. When the UE 106 changes or expands to the larger bandwidth 912 to measure the SSB 822, a potential interruption 940 may be introduced when receiving the first carrier signal 816 as a bandwidth adjustment 940 is performed to increase the bandwidth from 810 to 912. Similarly, when the UE 106 changes or decreases to the smaller bandwidth 916 after measuring the SSB 822, a potential interruption 942 may be introduced on the first carrier as the bandwidth is reduced from 912 to 916.

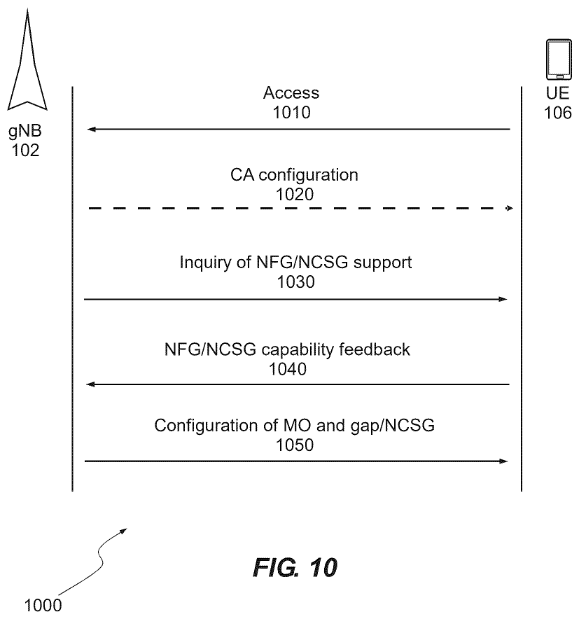

### FIG. 10: Flow Diagram of Signaling

FIG. 10 is an illustration of a flow diagram 1000 of procedures for signaling between the base station or gNB 102 and the UE 106 according to some example embodiments. The flow diagram 1000 shows an NFG and NCSG configuration procedure. In a first step 1010, the UE 106 can access the network or gNB 102. In an optional second step 1020, the gNB 102 can configure carrier aggregation (CA) for the UE 106. In a third step 1030, the gNB 102 can inquire regarding UE support of NFG and/or NCSG capabilities on certain target bands. In a fourth step 1040, based in part on the configured CA (if performed), the UE 106 can indicate or provide feedback on NFG support (e.g. gap or no-gap, and no-gap-with-interruption or no-gap-no-interruption) and NCSG support (e.g. gap, ncsg, or nogap-noncsg) on each target band. In a fifth step 1050, based on the feedback from UE 106, the gNB 102 may configure a gap or NCSG, as well as a measurement object (MO), for the UE 106.

However, NFG and NCSG functionalities are still two independent features in the 3GPP standard. From a Radio Performance and Protocol Aspect (e.g. radio access network group 4 (RAN4)) perspective, interruption design and measurement behaviors are different between the NFG and NCSG features. For example, interruption of NCSG can be based on a visible interruption length (VIL) pattern, which is explicitly configured by the gNB 102 based on UE 106 capability. As another example, interruption of NFG can be controlled by an interruption ratio, which can be explicitly specified in the 3GPP specification. The two NFG and NCSG features can have their own advantages and disadvantages. For example, the NFG feature may have a low interruption rate, but an interruption location may be invisible to the gNB 102. The gNB 102 may choose to enable different features in different scenarios. If the gNB 102 and the UE 106 support both NFG and NCSG features, then the UE 106 will not know which feature to enable. The UE 106 will not know which measurement behavior to implement.

### Solution 1: Explicit Enabling NFG or NCSG

In a first example, the NFG configuration or the NCSG configuration can be explicitly enabled. The term “NFG configuration” includes all of the elements of NGF as outlined in the Third Generation Partnership Project (3GPP) Technical Specification (TS) 38.133, such as TS 38.133 Rel. 18.2.0 (June, 2023). Similarly, the term “NCSG configuration” includes all the elements of NCSG as outlined in the Third Generation Partnership Project (3GPP) Technical Specification (TS) 38.133, such as TS 38.133, Rel. 18.2.0 (June, 2023). A new indication or parameter can be introduced via RRC signaling from the gNB 102 to the UE 106 to enable the NFG configuration. After the UE 106 receives the new indication, the UE 106 can enable the NFG configuration and perform RRM measurement. The RRM measurement, including measurement latency and scheduling availability, and corresponding interruption periods for NFG may apply.

If the gNB 102 configures the NCSG pattern in the fifth step 1050 of the signaling procedure, as shown in FIG. 10, the UE 106 can enable an NCFG configuration. Existing NCSG related measurements can apply.

The two features, namely the NFG configuration and the NCSG configuration, are not expected to be enabled simultaneously for measurement by the UE on the same target band because UE measurement behaviors can be different between the two features.

These indications or parameters can be communicated in an information element (IE) using radio resource control (RRC) signaling or another desired type of control or data signaling between the UE 106 and the gNB 102. Information elements (IEs) can be used to identify whether the UE 106 needs a gap to measure a target SSB 822. One IE is called NeedForGaps. The UE 106 can indicate, using the IE, whether the UE 106 needs a gap or no gap to measure the target SSB 822. Alternatively, the network or gNB 102 can use a similar information element, called network controlled small gap (NCSG), in which the network or gNB 102 can signal a gap period for a UE 106, if a gap is necessary for the UE 106 to measure a target SSB 822. This example is not intended to be limiting. The indications or parameters can be communicated in any IE that enables efficient communication between the UE and the gNB.

In one aspect, a UE 106, can have one or more processors 402, coupled to a memory 406, configured to decode, from signaling received from the gNB 106, an indication to enable one of Need For Gaps (NFG) or Network Configured Small Gap (NCSG) gapless measuring of a target synchronization signal block (SSB), e.g. SSB 822. The processors 402 can enable the NFG or NCSG gapless measuring based on the indication from the gNB 102 for Radio Resource Management (RRM) measurements of the target SSB 822. The processors 402 can perform the RRM measurements of the target SSB 822 using the NFG or NCSG gapless measuring as indicated by the gNB 106.

In another aspect, the processors 402 of the UE 106 can decode, from signaling received from the gNB 106, an inquiry indication regarding support of the UE 106 for gapless measurement support. The processors 402 can encode, for transmission to the gNB 106, a capability of the UE 106 to perform gapless measuring.

In another aspect, the gapless measuring of a target SSB 822 can be performed using an NFG configuration. In another aspect, the gapless measuring of a target SSB 822 can be performed using an NCSG configuration. In another aspect, the processors 402 of the UE 106 can be further configured to enable an NFG configuration based on the indication. In another aspect, processors 402 can be further configured to disable the NCSG configuration for performing the RRM measurements on a same frequency band when an NFG configuration is enabled. In another aspect, the processors 402 can be further configured to enable an NCSG configuration based on the indication. In another aspect, the indication can include a measurement gap parameter value for the target SSB 822.

In one aspect, a method for gapless measurement of a target SSB 822 can comprise decoding, at UE 106, from signaling received from the gNB 102, an indication to enable one of NFG or NCSG gapless measuring of a target SSB 822. In addition, the method can comprise enabling the NFG or NCSG gapless measuring based on the indication from the gNB 102 for RRM measurements of the target SSB 822. Furthermore, the method can comprise performing the RRM measurements of the target SSB 822 using the NFG or NCSG gapless measuring.

In another aspect, the method can comprise decoding, at the UE 106, from signaling received from the gNB 102, an inquiry indication regarding support of the UE 106 for gapless measurement support. The method can also include encoding, for transmission to the gNB 102, a capability of the UE 106 to perform gapless measuring.

In another aspect, the gapless measuring of a target SSB 822 can be performed using an NFG configuration. In another aspect, the gapless measuring of a target SSB 822 can be performed using an NCSG configuration. In another aspect, the method can include enabling an NFG configuration based on the indication. In another aspect, the method can include disabling the NCSG configuration for performing the RRM measurements on a same frequency band when an NFG configuration is enabled. In another aspect, the method can include enabling an NCSG configuration based on the indication.

### Solution 2: Implicit Enabling NFG or NCSG

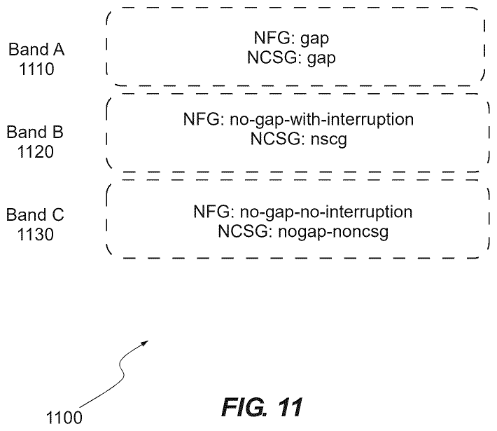

### FIG. 11: Schematic Frequency Band Diagram

FIG. 11 is an illustration of a schematic frequency band diagram 1100 according to some example embodiments. In a second example, the NFG configuration or the NCSG configuration can be implicitly enabled if the gNB 102 configures a legacy gap. The legacy gap configuration can be based on the RRC parameter of MeasGapConfig as defined in 3GPP TS 38.331, such as TS 38.331 Rel. 17.5.0 (July, 2023).

For frequency bands (e.g. Band A) 1110 on which the UE 106 indicates “gap” in a gap indication, e.g. “gapIndication”, in both the NFG configuration and the NCSG configuration, the UE 106 can use the legacy gap configuration for RRM measurements. The UE 106 shall not indicate “gap” in one of the features while indicating differently in another feature for the same target band. For example, the UE 106 shall not indicate “gap” in the NFG configuration while indicating “NCSG” or “nogap-noncsg” in the NCSG configuration. In another example, the UE 106 should indicate “gap” in the NCSG configuration if it indicates “gap” in the NFG configuration.

For frequency bands (e.g. Band B) 1120 on which the UE 106 indicates “no-gap-with-interruption” in the NFG configuration, or in which the UE 106 indicates “ncsg” in the NCSG configuration, the UE 106 shall use the legacy gap for RRM measurement.

For frequency bands (e.g. Band C) 1130 on which the UE 106 indicates “no-gap-no-interruption” in the NFG configuration, or in which the UE 106 indicates “nogap-noncsg” in the NCSG configuration, the UE 106 can perform RRM measurement outside the legacy gap configuration.

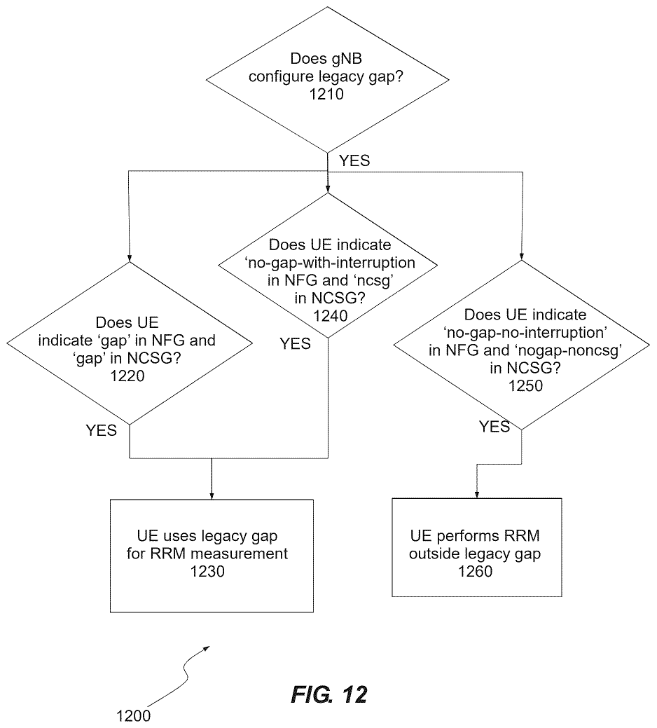

### FIG. 12: Method for Determining a Measurement Gap Configuration for RRM Measurements

FIG. 12 shows a method 1200 for determining a measurement gap configuration for RRM measurements according to some example embodiments. It should be understood that the method 1200 describes the operation of Solution 2 of the second example. The method 1200 is described from the standpoint of the UE 106 in conjunction with signaling from the network or gNB 102.

In 1210, the UE 106 determines if the gNB 102 configured a legacy gap. Alternatively, the gNB 102 configures a legacy gap. If so, the UE 106 determines the gapless measurement indication. In 1220, the UE 106 determines if the UE 106 indicates “gap” in a gap indication (e.g. “gapIndication”) in both NFG and NCSG. If so, the UE 106 uses legacy gap parameters for RRM measurement in 1230. In 1240, the UE 106 determines if the UE 106 indicates “no-gap-with-interruption” in NFG or “ncsg” in NCSG. If so, the UE 106 uses legacy gap parameters for RRM measurement in 1230. In 1250, the UE 106 determines if the UE 106 indicates “no-gap-no-interruption” in NFG or “nogap-noncsg” in NCSG. If so, the UE 106 can perform RRM measurements outside the legacy gap parameters in 1260.

In one aspect, an apparatus of a UE 106 can have one or more processors 402, coupled to a memory 406, to decode, from signaling received from a gNB 106, a gap configuration indication to use an existing gap configuration (e.g. a legacy gap) for RRM measurements on a target frequency band 822. The processors 402 can determine that gapless measuring was previously indicated to the gNB 102 for the RRM measurements of the target SSB 822 for the target frequency band. The processors 402 can perform the RRM measurements of the target SSB 822 using the gapless measuring based on the determination and the configuration indication.

In one aspect, the processors 402 can enable an NFG configuration based on determining that gapless measuring was previously indicated to the gNB 102. In another aspect, the processors 402 can disable an NCSG configuration from performing the RRM measurements on a same frequency band when the NFG configuration is enabled. In another aspect, the processors 402 can enable an NCSG configuration based on determining that gapless measuring was previously indicated to the gNB 102.

In another aspect, the processors 402 can determine that the UE indicated ‘gap’ for a gap indication (e.g. gapIndication) parameter in NFG configuration or indicated ‘gap’ for a gapIndication parameter in NCSG configuration for the frequency band, as shown in Band A 1110 in FIG. 11, that was previously indicated to the gNB 102 for the RRM measurements of the target SSB 822 for the frequency band. In another aspect, the processors 402 can perform the RRM measurements of the target SSB 822 for the frequency band Band A 1110 using an existing gap configuration based on the UE 106 indicating ‘gap’ for the gapIndication parameter in the NFG configuration indication or indicating ‘gap’ for the gapIndication parameter in the NCSG configuration for the frequency band.

In another aspect, the processors 402 can determine that the UE 106 indicated ‘no-gap-with-interruption’ for a gap indication (e.g. gapIndication) parameter in NFG configuration or ‘ncsg’ for a gapIndication parameter in an NCSG configuration, as shown in Band B 1120 in FIG. 11. In another aspect, the processors 402 can perform the RRM measurements of the target SSB 822 for the frequency band using an existing gap configuration based on the UE 106 indicating ‘no-gap-with-interruption’ for the gapIndication parameter in the NFG configuration or indicating ‘ncsg’ for the gapIndication parameter in the NCSG configuration for the frequency band.

In another aspect, the processors 402 can determine that the UE 106 indicated ‘no-gap-no-interruption’ for a gapIndication parameter in an NFG configuration or ‘nogap-noncsg’ in a gapIndication parameter in an NCSG configuration for the frequency band, as shown in Band C 1130 in FIG. 11. In another aspect, the processors 402 perform the RRM measurements of the target SSB 822 for the target frequency band outside of the existing gap configuration based the UE 106 indicating ‘no-gap-no-interruption’ for the gapIndication parameter in the NFG configuration or ‘nogap-noncsg’ for the gapIndication parameter in the NCSG configuration for the target frequency band.

In one aspect, a method for gapless measurement of a target SSB 822 can comprise decoding, at a UE 106, from signaling received from a gNB 102, a gap configuration indication to use an existing gap configuration for RRM measurements on a target frequency band. The method can comprise determining that gapless measuring was previously indicated to the gNB 102 for the RRM measurements of the target SSB 822 for the target frequency band. The method can also comprise performing the RRM measurements of the target SSB 822 using the gapless measuring based on the determination and the configuration indication.

In another aspect, the method can comprise enabling an NFG configuration based on determining that gapless measuring was previously indicated to the gNB 102. In another aspect, the method can comprise disabling an NCSG configuration for performing the RRM measurements on a same frequency band when the NFG configuration is enabled. In another aspect, the method can comprise enabling an NCSG configuration based on determining that gapless measuring was previously indicated to the gNB 102.

In another aspect, the method can comprise determining that the UE 106 indicated ‘gap’ for a gap indication (e.g. gapIndication) parameter in an NFG configuration or indicated ‘gap’ for a gapIndication parameter in an NCSG configuration that was previously indicated to the gNB 102 for the RRM measurements of the target SSB 822 for the frequency band, as shown in Band A 1110 in FIG. 11. In another aspect, the method can comprise performing the RRM measurements of the target SSB 822 for the frequency band using an existing gap configuration based on the UE 106 indicating ‘gap’ for the gapIndication parameter in the NFG configuration or indicating ‘gap’ for the gapIndication parameter in the NCSG configuration for the frequency band.

In another aspect, the method can comprise determining that the UE 106 indicated ‘no-gap-with-interruption’ for a gap indication (e.g. gapIndication) parameter in an NFG configuration or ‘ncsg’ for a gapIndication parameter in an NCSG configuration for the frequency band, as shown in Band B 1120 in FIG. 11. In another aspect, the method can comprise performing the RRM measurements of the target SSB 822 for the frequency band using an existing gap configuration based on the UE 106 indicating ‘no-gap-with-interruption’ for the gapIndication parameter in the NFG configuration or indicating ‘ncsg’ for the gapIndication parameter in the NCSG configuration for the frequency band.

In another aspect, the method can comprise determining that the UE 106 indicated ‘no-gap-no-interruption’ for a gapIndication parameter in an NFG configuration or ‘nogap-noncsg’ in a gapIndication parameter in an NCSG configuration for the frequency band, as shown in Band C 1130 in FIG. 11. In another aspect, the method can comprise performing the RRM measurements of the target SSB 822 for the target frequency band outside of the existing gap configuration based the UE 106 indicating ‘no-gap-no-interruption’ for the gapIndication parameter in the NFG configuration or ‘nogap-noncsg’ for the gapIndication parameter in the NCSG configuration for the target frequency band.

### Solution 3: Implicit Enabling NFG or NCSG With Timer

In a third example, the NFG configuration or the NCSG configuration can be implicitly enabled and can introduce a timer (e.g. T_{NFG}) to control application of an NFG configuration. Unlike the NCSG configuration, enabling the NFG configuration does not require a gap related configuration.

After receiving an inquiry from the NW or gNB 102 (step 3 in FIG. 10), a UE 106 can provide feedback of NFG and NCSG support on every target band (step 4 in FIG. 10). In accordance with solution 1 described above, the UE 106 can know which feature to enable after receiving a gap related configuration, such as an NCSG configuration, a legacy gap configuration or new indication of enabling an NFG configuration. However, the gNB 102 determines when to provide the gap related configuration to the UE. Before receiving the gap related configuration from the gNB 102, the UE 106 does not know which feature or configuration to enable in order to perform RRM measurements. In one embodiment, a timer can be used to enable the UE to identify which feature or configuration to enable.

In one example, a new timer T_{NFG} can be configured to start upon completion of feedback of NFG and NCSG support, i.e. after completing step 4 in FIG. 10. At expiration of the timer T_{NFG}, the UE 106 can perform RRM measurement on frequency bands on which the UE 106 indicates ‘no-gap’, ‘no-gap-with-interruption’, or ‘no-gap-without-interruption’ in the NFG feedback following network function discovery (NFD) related requirement as specified in 3GPP Rel. 18 TS 38.133, such as TS 38.133 Rel. 18.2.0 (June, 2023). If an indication is received at the UE prior to the expiration of the timer, then the timer T_{NFG} can stop upon reception of configuration of measGapConfig or a new indication to enable the NFG configuration.

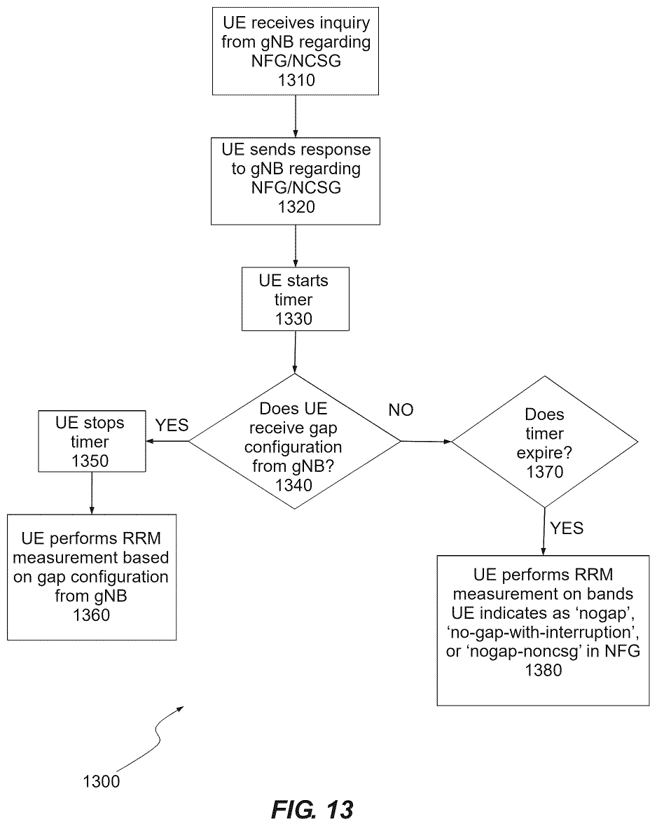

### FIG. 13: Method for Determining a Measurement Gap Configuration for RRM Measurements

FIG. 13 shows a method 1300 for determining a measurement gap configuration for RRM measurements according to some example embodiments. It should be understood that the method 1300 describes the operation of Solution 2 of the third example. The method 1300 is described from the standpoint of the UE 106 in conjunction with signaling from the network or gNB 102.

In 1310, the UE 106 can receive an inquiry from the gNB 102 regarding NFG and NCSG capabilities. In 1320, the UE 106 can provide feedback regarding NFG and NCSG support of one or more target bands. In 1330, the UE 106 can start a timer T_{NFG}. In 1340, the UE 106 can determine if a gap configuration has been received from the gNB 102. If so, the UE 106 can stop the timer in 1350 and perform RRM measurements based on the gap configuration received from the gNB 102 in 1360. If not, the UE 106 can determine if the timer has expired in 1370. If so, the UE can perform RRM measurements on bands that the UE indicates as “nogap”, “no-gap-with-interruption” or “nogap-noncsg” in NFG in 1380.

In one aspect, an apparatus of a UE 106 can have one or more processors 402, coupled to a memory 406, to encode, for transmission to a gNB 102, a capability message indicating support of the UE 106 for NFG and NCSG for RRM measurements of target SSB 822 on one or more frequency bands. The processors 402 can initiate a timer T_{NFG} upon transmission of the capability message. The processors 402 can perform the RRM measurements of the target SSB 822 on the one or more frequency bands that indicate support of NFG with no-gap based on determining the gNB 102 failed to provide gap configuration information to the UE 106 prior to an expiration of the timer T_{NFG}.

In another aspect, the processors 402 can determine that the gNB 102 has provided gap configuration information prior to the expiration of the timer T_{NFG}. In addition, the processors 402 can perform the RRM measurement of the target SSB 822 on one or more frequency bands based on the gap configuration information provided by the gNB 102. In another aspect, the processors 402 can stop the timer T_{NFG} upon a reception of gap configuration information at the UE 106 from the gNB 102.

In another aspect, the processors 402 can initiate the timer T_{NFG} upon completing the transmission of the UE capability information to the gNB 102.

In another aspect, the processors 402 can determine that the gNB 102 has provided an indication to use an existing gap configuration or an NCSG configuration prior to the expiration of the timer T_{NFG}.

In another aspect, the processors 402 can perform the RRM measurements according to an NFG configuration.

In another aspect, the target SSB 822 can be located outside an active bandwidth part (BWP) of the UE 106 and within a channel bandwidth (CBW) of the UE 106.

In another aspect, the processors 402 can disable NCSG based on a lack of gap configuration information from the gNB 102 upon expiration of the timer T_{NFG}.

In one aspect, a method for gapless measurement of a target SSB 822 can comprise encoding, at a UE 106 for transmission to a gNB 102, a capability message indicating support of the UE 106 for NFG and NCSG for RRM measurements of target SSB 822 on one or more frequency bands. In addition, the method can comprise initiating a timer T_{NFG} upon transmission of the capability message. Furthermore, the method can comprise performing the RRM measurements of the target SSB 822 on the one or more frequency bands that indicate support of NFG with no-gap based on determining the gNB 102 failed to provide gap configuration information to the UE 106 prior to an expiration of the timer T_{NFG}.

In another aspect, the method can comprise determining that the gNB 102 has provided gap configuration information prior to the expiration of the timer T_{NFG}. The method can comprise performing the RRM measurement of the target SSB 822 on one or more frequency bands based on the gap configuration information provided by the gNB 102.

In another aspect, the method can comprise stopping the timer T_{NFG} upon a reception of gap configuration information at the UE 106 from the gNB 102.

In another aspect, the method can comprise initiating the timer T_{NFG} upon completing transmission of the UE capability information to the gNB 102.

In another aspect, the method can comprise determining that the gNB 102 has provided an indication to use an existing gap configuration or an NCSG configuration prior to the expiration of the timer T_{NFG}.

In another aspect, the method can comprise performing the RRM measurements according to an NFG configuration.

In another aspect, the target SSB 822 can be located outside an active bandwidth part of the UE 106 and within a channel bandwidth of the UE 106.

In another aspect, the method can comprise disabling NCSG based on a lack of gap configuration information from the gNB 102 upon expiration of the timer T_{NFG}.

In a fourth example, a pre-defined timer T_{X} can be introduced that is similar to the timer T_{NFG} described herein except that the pre-defined timer T_{X} can have a fixed value pre-defined is a specification. For example, the pre-defined timer T_{X} can equal a value such as 20 ms, 50 ms, etc.

As described herein, new UE capabilities can be introduced, namely new UE capability X1 to indicate that the UE 106 is capable or recognizing new indication from the gNB 102 to the UE 106 to enable NFG, and new UE capability X2 to indicate support of the new timer T_{NFG}. The new UE capabilities X1 and X2 can be per UE or per frequency range.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus of a user equipment (UE), the apparatus comprising:
one or more processors, coupled to a memory, configured to:
decode, from signaling received from a next generation node B (gNB), an indication to enable one of Need For Gaps (NFG) or Network Configured Small Gap (NCSG) gapless measuring of a target synchronization signal block (SSB);
enable the NFG or NCSG gapless measuring based on the indication from the gNB for Radio Resource Management (RRM) measurements of the target SSB; and
perform the RRM measurements of the target SSB using the NFG or NCSG gapless measuring as indicated by the gNB.

2. The apparatus of claim 1, wherein the one or more processors are further configured to:
decode, from signaling received from the gNB, an inquiry indication regarding support of the UE for gapless measurement support; and
encode, for transmission to the gNB, a capability of the UE to perform gapless measuring.

3. The apparatus of claim 1, wherein the gapless measuring of a target SSB is performed using an NFG configuration.

4. The apparatus of claim 1, wherein the gapless measuring of a target SSB is performed using an NCSG configuration.

5. The apparatus of claim 1, wherein the one or more processors are further configured to enable an NFG configuration based on the indication.

6. The apparatus of claim 5, wherein the one or more processors are further configured to disable the NCSG configuration for performing the RRM measurements on a same frequency band when an NFG configuration is enabled.

7. The apparatus of claim 1, wherein the one or more processors are further configured to enable an NCSG configuration based on the indication.

8. The apparatus of claim 1, wherein the indication includes a measurement gap parameter value for the target SSB.

9. A method for gapless measurement of a target Synchronization Signal Block (SSB), the method comprising:
decoding, at a user equipment (UE) from signaling received from a next generation node B (gNB), an indication to enable one of Need For Gaps (NFG) or Network Configured Small Gap (NCSG) gapless measuring of a target SSB;
enabling the NFG or NCSG gapless measuring based on the indication from the gNB for Radio Resource Management (RRM) measurements of the target SSB; and
performing the RRM measurements of the target SSB using the NFG or NCSG gapless measuring.

10. The method of claim 9, further comprising:
decoding, from signaling received from the gNB, an inquiry indication regarding support of the UE for gapless measurement support; and
encoding, for transmission to the gNB, a capability of the UE to perform gapless measuring.

11. The method of claim 9, wherein the gapless measuring of a target SSB is performed using an NFG configuration.

12. The method of claim 9, wherein the gapless measuring of a target SSB is performed using an NCSG configuration.

13. The method of claim 9, further comprising enabling an NFG configuration based on the indication.

14. The method of claim 13, further comprising disabling an NCSG configuration for performing the RRM measurements on a same frequency band when an NFG configuration is enabled.

15. The method of claim 9, further comprising enabling an NCSG configuration based on the indication.

16-57. (canceled)

58. An apparatus of a user equipment (UE), the apparatus comprising:
one or more processors, coupled to a memory, configured to:
decode, from signaling received from a next generation node B (gNB), an inquiry indication regarding support of the UE for gapless measurement support;
encode, for transmission to the gNB, a capability of the UE to perform gapless measuring;
decode, from signaling received from the gNB, an indication to enable one of Need For Gaps (NFG) or Network Configured Small Gap (NCSG) gapless measuring of a target synchronization signal block (SSB);
enable the NFG or NCSG gapless measuring based on the indication from the gNB for Radio Resource Management (RRM) measurements of the target SSB; and
perform the RRM measurements of the target SSB using the NFG or NCSG gapless measuring as indicated by the gNB.

59. The apparatus of claim 58, wherein the gapless measuring of a target SSB is performed using an NFG configuration.

60. The apparatus of claim 58, wherein the gapless measuring of a target SSB is performed using an NCSG configuration.

61. The apparatus of claim 58, wherein the one or more processors are further configured to enable an NFG configuration based on the indication.

62. The apparatus of claim 58, wherein the one or more processors are further configured to enable an NCSG configuration based on the indication.
